(19) United States
(12) Patent Application Publication
(10) Pub. No.: US 2024/0304100 A1
(43) Pub. Date: Sep. 12, 2024

(54) EDUCATIONAL ANALYTICS PLATFORM AND METHOD THEREOF

(71) Applicant: EMAGINOS INC., Marina del Rey, CA (US)

(72) Inventors: Scott Taub, Marina del Rey, CA (US); Allan Jones, Sterling, VA (US); Keith Larick, Sacramento, CA (US); William Varney, San Diego, CA (US)

(73) Assignee: EMAGINOS INC., Marina del Rey, CA (US)

(21) Appl. No.: 18/563,756

(22) PCT Filed: May 25, 2022
(86) PCT No.: PCT/US2022/030873

§ 371 Date: Nov. 22, 2023

Related U.S. Application Data
(60) Provisional application No. 63/192,601, filed on May 25, 2021.

(51) Int. Cl. G09B 5/08; G06F 16/27

(52) U.S. Cl. CPC G09B 5/08; G06F 16/27

(57) ABSTRACT

A system for generating a customized instructional content is disclosed. A processor executes a machine learning element. A plurality of separate databases each including independent information relative to disparate factors. A machine learning element includes an aggregator for aggregating data populating the plurality of separate databases for generating an aggregate database populated by the disparate factors. The machine learning element transforms the aggregate database to customized instructional content based upon statistical trends and anomalies learned from the disparate factors populating the aggregate database.

The present application claims priority to International Patent Application No.: PCT/US2022/030873 filed May 25, 2022, which claims priority to U.S. Provisional Patent Application No. 63/192,601 filed on May 25, 2021, the contents of which are included herein by reference.

### TECHNICAL FIELD

The present invention relates generally toward this system for generating customized instructional content. More specifically, the invention is related to the use of artificial intelligence and machine learning to transform disparate information contained in multiple formats and databases to generate individualized instructional content.

### BACKGROUND

Aristotle is frequently quoted as saying, “the whole is greater than the sum of the parts.” However, this is only true when the whole emerges as something other than a heap of parts. In other words, only if the parts are deliberately combined systematically into some new, transformed entity taking advantage of unforeseen synergies does an enhanced, new entity emerge. While today's society is data driven, data is often not used to achieve improved, coordinated content.

It is well known that records are maintained via computer databases for multiple informational purposes. For example, educational institutions maintain databases tabulating a variety of information that often is not used in a manner that may improve educational outcomes for a student. One database may be used to keep records of a student's grades. Another database may keep records associated with socioeconomic information, family information, income level, extracurricular activities and the like.

Independent databases maintained by school districts include, but are not limited to, student information described above, learning management systems, district and individual business and finance, purchasing data, human resources, food services, community relations, transportation, facilities management, security, communications, curriculum resources, and local state and federal reporting. Little advantage is made of this vast volume of data because these databases are independently operated and little effort it's made to identify useful synergies that may improve educational outcomes. Other than application program interfaces (API) that are not generally adapted for manual examination of individual files, these databases continue to be maintained independently.

It would be desirable to take full advantage of the data included in these independent databases to generate customized educational platforms. Improving performance of individuals making use of data not previously thought to provide synergistic elements to a new platform has not only been elusive, but not previously contemplated, particularly in an educational environment. Therefore, creative solutions are required to advance the use of data to improve performance and opportunities in a ways not previously thought achievable.

### SUMMARY

A system for generating a customized instructional content is disclosed. A processor executes a machine learning element. A plurality of separate databases each include independent information relative to disparate factors. These databases include but are not limited to data associated with student information, demographics, standard performance, socioeconomic disposition, learning management systems, district and individual business and finance, purchasing data, human resources, food services, community relations, transportation, facilities management, security, communications, curriculum resources, and local state and federal reporting. A machine learning element includes an aggregator for aggregating data populating the plurality of separate databases for generating an aggregate database populated by the disparate factors. The machine learning element transforms the aggregate database to customized instructional content based upon statistical trends and anomalies learned from the disparate factors populating the aggregate database.

Without exclusion to other uses as in corporate, government, NGO and the like, the system is uniquely suited to provide a K-12 school analytic platform. The system manages and optimizes all the operations of a K-12 public school district. The following description is merely exemplary in nature and is not intended to limit the present disclosure, application, or uses.

The system delivers a platform for integrating all the devices and applications that traditionally operate independently. Calling today's K-12 public education a system is a misnomer. It could better be described as a collection of components trying to collaborate in delivering quality education to the students. The components include everything from student handheld devices to the computer or cloud servers where the applications reside, including the network on which everything communicates.

The functions/applications include literally every operation in the district, including but not limited to:
Student information system
Learning management system
Business and finance
Purchasing
Human resources
Food service
Community relations
Transportation
Facilities management
Security
Communications
Curriculum resources
Local, State, and Federal reporting

Historically, by operating these domains independently, the district loses valuable opportunities for reducing costs, improving services, and better meeting the students' learning needs. Many of the systems are maintained in separate, unrelated databases that have no external coordination rendering the data of little use. The system of the present invention overcomes these issues

Former Secretary of Defense, Donald Rumsfeld pointed out, “There are known knowns. These are things we know that we know. There are known unknowns. That is to say, there are things that we know we don't know. But there are also unknown unknowns. There are things we don't know we don't know.” Hidden in all their data, school districts have many unknown unknowns. A well-designed and implemented analytics platform provides alerts when an unknown unknown variable poses a threat or provides an opportunity.

The system of the present invention enhances data integrity and validity. The system platform is an analytics engine fueled by massive volumes of raw data that delivers actionable information to the end-user. The first function is to ensure data integrity across all applications. The system will create and manage a district data dictionary that defines what person/position in the district is authorized to change it and is responsible for the validity of each data element in every application. Demographics like marriages, divorces, adoptions, transfers, moves, and name changes frequently result in changes in the data that must be controlled, managed, and promulgated across all applications and reports.

Instead of storing data in what are referred to as ‘islands of information,’ all applications will point to a single data element for that content. Changing the master data element effectively changes it in every application that uses that data element. For example, there may be several applications that use the student's primary guardian data. The official name of the guardian will be stored in the computer or cloud and owned by the person responsible for student registration data. Any other application that uses the information will point to that data element in the cloud. Anyone learning of a change in the guardian data will submit the information to the student registration data manager who will confirm or deny the change. Up to this point, this is normal operational procedure. Under System, the platform will determine if the change should trigger other changes in other databases such as an address change that effects the transportation application database.

In many districts, preparing and submitting mandated state and federal reports consume weeks of staff time-much of which is used just to validate the data that has been gathered from various applications. System not only eliminates the data validity issues, but it also generates the reports automatically-flagging issues for review and approval by comparing data patterns and identifying anomalies. This process aggregates all the district data into a single relational database with appropriate security and access controls. This collected data is the primary asset used in implementing the system analytics platform.

System then aggregates data from districts across the country (without connecting it to individuals by name) creating a massive pool of data for analysis and understanding what works and what needs to change.

Identifying and using factors that can improve performance of an individual in an educational or other setting is achieved for the first time. The aggregator of the present invention provides the ability to identify trends from disparate data included in separate (and unrelated) databases to not only predict individual performance but to generate customized content that can overcome hindrances to that individual's performance. Trends may be identified by the aggregator and a machine learning algorithm not previously thought related or relevant. For example, trends and even anomalies may be identified that are associated with high performance or low performance for a group of individuals having common or merely overlapping characteristics. The aggregator makes use of machine learning to continuously identify improved processes or procedures that may be adapted for individuals to increase probability of success in an educational, work or other environment.

### DETAILED DESCRIPTION

The system of the present invention functions as an analytics engine populated by massive volumes of disparate raw data providing end user information that has been transformed by identifying synergies not previously thought relevant. System algorithms access and identify databases that include, for example, marital status, adoptions, business transfers, residential changes, and other socioeconomic information such as, for example, race, first language, and country of origin.

Rather than storing data in what might be referred to as an “island of information” the system application points to a single data element for each content. Changing the master data element effectively changes it in every application that uses that data element. For example, there may be several independent applications a separate databases that identify primary guardian data of an individual or student. The official name of the guardian is stored in the system computer server, or even cloud and is owned by the person responsible for student registration data. Customarily, the change in the guardian data is submitted to a registration data manager who confirms or denies the change in guardianship. A change of this nature triggers the system to identify other independent databases where in the change should also occur and identify additional information that should also change such as, for example, residence, transportation needs, and dietary requirements, the purpose of which will become more evident here in below. The system of the present invention identifies overlap or synergies between disparate factors stored in these separate databases that otherwise would be useless information.

By way of non-limiting example, the aggregator of the present invention identifies a single database in which a modification such as guardianship (or other factor) has been made and pins guardianship for future analysis. The system is also capable of signaling such modifications to other of the independent databases so that did the integrity is maintained across all of the independent databases. During this process, the system aggregates all the district data into a single relational database that includes appropriate security and access controls as will be further explained here and below. This information is provided to the machine learning and analytics platform. As used herein, “factor” should be understood to mean, “a circumstance, fact, or influence that contributes to a result or outcome.”

In one embodiment, the aggregate information is only temporarily stored in the system server providing the ability to extract desired data elements. However, the data may comprise meta-data abstraction layers that are alive and accessible only temporarily until analysis is performed. In some instances, reports are generated and provided to State, Federal or other agencies to remove burden on the staff associated with any educational district. Thus, non-relational database applications are implemented for only temporarily storing data in what is referred to as a non-structured query language (SQL) database. For security, the metadata disappears after use.

A sophisticated analytical approach is used to make use of the data comprising the independent databases and adopts artificial intelligence (AI) and machine learning approaches. These approaches not only provide high quality analysis but also improve analysis with increasing volumes of data. Human inspection error associated with large volumes of data is all but eliminated.

AI systems are believed to not only conduct statistical analysis of disparate data but are also capable of establishing new programs and processes from both trends anomalies in the data. In this system, AI algorithms such as trend identification and outcome prediction established through Machine Learning (ML) algorithms have been implemented. Deep-Learning (DL) and neural networks have been identified as feasible for AI analysis due to the implementation of learning-based algorithms. Learning based DL neural networks such as Conventional Neural Networks (CNN) are examples of such algorithms. These CNNs are trainable to learn trends and identify anomalies for generating a machine learning model used to prepare individualized educational platforms.

CNNs using sophisticated algorithms that exceed human accuracy in a fraction of the amount of time required of human analysis that has previously altogether prevented this type of analysis having been conducted. These CNNs are trainable to detect trends and anomalies in the data under analysis by using the trained statistical AI model. Once an aggregate database has been established, the CNNs or other machine learning algorithms perform the transformation of the data into usable subsets of the aggregate data, enabling generation of individualized educational platforms that statistically increase probability of student success.

As set forth above, while a non-limiting embodiment, the system of the present invention is uniquely suited for customizing educational platforms. The system generates aggregated data that is analyzed to meet the unique needs of each student, or even educational professional. For security, the aggregate data may be stored via encryption-decryption-encryption (“EDE”) services and/or followed by deletion.

By way of non-limiting example, classrooms are populated by up to thirty students or more in which standard assignments, such as quizzes, tests, oral and written reports, are assigned to measure student performance. Little or no customization is included in this paradigm. Dynamic adjustment of student educational platform and learning experience presents challenges that prevent customization to meet individual student needs. Often, a group approach is implemented, and group progress is tracked irrespective of individual performance. The system of the present invention overcomes these difficulties by making use of data not readily available to an individual instructor to provide observational rubrics to enhance a teacher's ability to assess student performance in real time.

During the period of a school year, an instructor enters grades for each student into an educational database. These grades whether percentages or customary alphabetic tracking provide feedback to the teacher, parents, or guardian of an individual student. For example, a student may be excelling in mathematics with high grade marks while performing poorly in English or history. This anomaly is often attributed to right- or left-brain thinking students, without any analysis as to what might be driving this performance. Regardless, throughout the course of a school year or multiple school years, grades of each student are electronically stored in an educational database.

The system accesses the separate databases that includes data for each student and begins population of the aggregate database to begin generation of a statistical trend analysis. Thusly, academic outcomes are tracked for existing and already implemented educational platforms. However, unrelated databases are accessed to identify student demographics ranging from nation of origin or ethnicity to economic background, and even education level of student guardians. All of this information is stored in the aggregate database from which heretofore unknown analysis may now be conducted.

Once the aggregate database has been populated with data associated with an individual student, or more importantly full cross sections of students in a given school, school district or even plurality of school districts the AI takes over to identify trends associated with any of the datasets and to develop customized educational platforms statistically believed to improve student performance. For example, an individual nine year old student coming from a Hispanic background and single parent family maybe underperforming in long division. The aggregate database identifies an educational platform that has proven successful for other students having the same demographics. Once the AI algorithm identifies the successful educational platform it generates statistical probability of success of implementing such platform to the student having difficulty. Once identified, the educator is provided the educational platform and may implement it on an individual basis to the struggling student. It is within the scope of this invention that a combination of existing educational platforms based upon trend analysis may be generated to create a new platform.

Furthermore, the aggregate database includes data from other districts enabling a broad range of predictive outcomes to be generated by the AI algorithm to approve probability of success. Multiple educational platforms may be generated each being assigned a probability of success for an individual student enabling alternative approaches to be generated in real time if one platform does not prove successful.

So long as student performance is tracked by way of teachers entering grades into the educational database that is accessed by the system of the present invention, dynamic educational platforms may be generated for individual students throughout a school year when comparative analysis is performed relative to institute educational programs or platforms. Thus, the educational platform is continually adjusted in a manner that will keep students actively engaged in a learning process based upon an AI statistical approach. In this manner, the learning process is emphasized instead of traditional memorization and recall of facts enabling students to become independent lifelong learners.

Rote learning procedures have been used for generations but are often maligned as being ineffective as an educational tool. However, arithmetic is an example with basic skill that can best be learned through rote memorization. More recently, rote learning of mathematics has included the use of games to practice and measure student progress. These games maybe useful for one student background but not another. Using the AI statistical approach of the present invention, rote learning maybe customized to suit any social economic background, family history, educational history or heritage. It is important to note that aggregate data from the multiple databases is used to make this analysis that includes multiple social factors and not just a single factor such as, for example, ethnicity. As such, two students with the same ethnicity may be assigned two separate learning platforms for any given subject that are, based upon statistical AI analysis are believed to be most likely to achieve educational success.

Reference is made to generation of an educational platform. The educational platform is not generated in a vacuum but is built upon existing educational platforms. At least one of the databases preferably includes information relevant to education such as, but not limited to, textbooks in use, Internet availability to an individual classroom, home access to the Internet, Internet educational services, and the like. Therefore, each one of these educational resources are associated with student performance so the AI algorithms may assess which have proven successful (or unsuccessful) for a given student demographic. The AI algorithm may also identify anomalies in the statistical data that may show student success that is outside the statistical average. The AI algorithm stores the statistical data and continues to monitor in real time, similar outcomes to establish a new educational platform that may enhance the probability of student success.

In one embodiment, weighted averages are used for each demographic. The weighted averages are continuously updated based on machine learning. For example, a particular weight may be assigned to single parent status and a different weight assigned to economic status of an individual student. These weights may be instrumental in establishing an educational platform when the algorithm determines one demographic is more important than another based on the statistical data of the aggregate database. Over time, one demographic may decrease in its impact on the ability of a student to succeed; from which the machine learning will decrease the weight assigned to that particular demographic.

The system of the present invention also identifies educational opportunities from which one student may work with another student on a particular topic. If student A is struggling to understand a concept and student B has mastered that concept, the system will signal an educator to connect the students and encourage the students to collaborate until both have mastered the concept. The AI algorithm analyzes all of the databases to match two students having demographics most likely to lead to success. This data continues to populate the aggregate database, machine learning takes over and may adjust the demographics most likely to lead to success for the two students based on educational results entered by a prospective educator.

The aggregate database is not limited to student data, but also generates customized educational platforms for educators and teachers. While the system constantly tracks student performance and analyzes educational results, these results are also attributed to an individual educator or teacher. In this way, developmental criteria may be established for any given teacher. Similar demographics as those tracked for the students are also tracked for the educators. Also included in this educational background is teacher qualifications and skills that are analyzed by the AI algorithm against student performance. The system monitors student and teacher performance in real time and uses machine learning to recognize patterns that are indicative of opportunities for improvement by prescribing customized professional development plans that strengthen each educator individually. Thus, the system may recommend development activities and identify opportunities for improving educational performance. In addition, programs and resources are identified that may improve an educator's performance based on statistics generated from the aggregate database.

While countless professional development programs and resources are available for training and developing educators, none are necessarily identified to overcome a specific weakness or area of identified improvement. For example, by accessing an educator's textbooks, test information, and any other resources an individual teacher uses, the system can identify not only individualized programs, but colleagues having similar individual and student demographics who may act as a mentor. A mentor is also provided with a training plan that is based upon statistical success profiles generated by the aggregator to customize educational resource. Certification may also be provided to individual educators based upon completion of an individualized training program. Willingness to participate and mentor other teachers may be required and tracked to maintain certification.

Because the system functions in real time, current events may be addressed while still relevant. Educators and teachers, upon inquiry from students, may access the system with inquiries relevant to student interest, grade level, and any other metrics that may enable the system to provide relevant educational content. Based upon each of these metrics, the system prepares research protocols that are age and skill set appropriate. The research protocols provide student pathways enabling students to generate answers to their own questions while leading the students toward more detailed research with a goal of fulfilling the curiosity of any student for a given topic. All of these protocols are directed by AI based upon the content of the aggregate database that will generate improved probability of a successful, self-guided research initiative.

In this embodiment, the system provide self-guided research that integrates, measures then records mastery by a student of appropriate learning standards. For example, a standard for initiating a research project is, “ask and answer questions about key details in a text.” The text includes content that is broader than a textbook or literature. Accessing the Internet provides the ability to identify information relevant to any current event, while the system of the present invention provides direction to a student based upon relevant metrics providing individualized protocols to research politics, medicine, prevention, cures, biology, virology, etc. Entering research results into the system including grades and assessments by a teacher, enabling the AI to continuously update research protocols based on ever changing educational results, current events, and socio-metrics of an individual student.

By generating individualized, self-directed educational systems using the aggregate database, real time optimization is achievable. So long as individual students' information in any of the separate databases is current, an educational platform may be continuously updated based on statistical probability of success. Thus, a student curiosity maybe integrated into an individualized educational program enhancing probability for a successful educational experience. A student interest may be entered periodically by the student or teacher into the educational database that is accessed to populate the aggregate database. Changing or shifting interests that are entered into the educational database enables the system to continuously update an educational program for an individual student while also considering all of the student metrics and demographics from each of the independent databases. As set forth above, changes in family structure are included in the generation of the individualized program. Engaging the student in a manner relevant to the student's interests and metrics provides the student with skills and confidence to become a lifelong learner.

The aggregate database is also structured to correlate student performance with a given educator or teacher. Thus, the system constantly monitors an educator's performance based upon student achievements to identify an educator's competencies and weaknesses. Correlating an educator's metrics with the socioeconomic and performance characteristics of a student body enables the AI to identify optimized teaching strategies for that student body. A qualified teacher may adopt the teaching strategy that worked perfectly with one student body but not another. For example, the teaching strategy may be successful in an African American community but not be successful in, for example, a Hispanic community. The AI can identify this disconnect and provide an educator, in real time, an alternative teaching strategy that would be successful with the Hispanic community by matching the demographics with positive results contained in the aggregate database. Still further, the system can use the metrics of any teacher to identify optimal mentors that may assist with implementation and improvement of a given teaching strategy. It should be understood that this provides professional development to all educators including self-directed activities to achieve professional educational credits.

Because the system of the present invention is completely digital, it is completely adaptable to unconventional educational programs as has been adopted during pandemic lockdowns. Anywhere/anytime learning is now enhanced because individualized educational programs are delivered directly to students through smart devices. Lesson plans are accessed by students on a daily basis via smart devices, and more importantly are updated constantly based upon student input and results that populate the educational database, and subsequently the aggregate database enabling the AI to generate real time enhancements statistically believed to improve learning results. Furthermore, educators and parents are enabled to monitor student progress of the individualized learning experience, enabling interaction not previously thought achievable. Still further, the system may identify students with common interests or demographics enabling educators to connect these students, providing support to limit the pratfalls of isolated learning. Teachers and educators also having similar interest and demographics may be connected with these students even though the teachers and educators are disposed in different grades or other classes previously unavailable to these students with the similar interest and demographics.

Federally standardized curriculums have been identified by over forty eight states that have developed Common Core State Standards (CCSS) to set clear college and career ready standards for kindergarten through 12th grade in English language, arts, literacy, and mathematics. While many standards exist the use of CCSS is designed to ensure that students graduating from high school are prepared to take credit bearing introductory courses in two or four year college programs or have core competencies to enter the workforce. Whether CCSS or other standardized curriculum is adopted by any district or state, the system of the present invention is adaptable to integrate CCSS in its machine learning algorithm.

Making use of CCSS standards that clearly demonstrate what students are expected to learn at each grade level enables parents and teachers to understand and support their learning. CCSS standards are enhanced by integration of the demographic data aggregated by the system into the aggregate database. Presently, the CCSS standards are:
Research and evidence based.
Clear, understandable, and consistent.
Aligned with college and career expectations.
Based on rigorous content and the application of knowledge through higher-order thinking skills.
Built upon the strengths and lessons of the current state standards.
Informed by other top-performing countries to prepare all students for success in our global economy and society.

According to best available evidence, mastery of each standard is essential for success in college, career, and life in today's global and highly technical economy. The invention of the present application implements standards to build projects and lessons that teach students not only academic content but also the process of learning. Thus, not only are the CCSS standards used as a guide, but machine learning also makes use of these standards when analyzing the aggregate database and continuously improving educational protocols based upon learned successful educational programs.

By way of example, the following sets forth one non limiting embodiment useful for selection of first grade reading standards (the first ten) that the AI accesses to build an educational program statistically identified to achieve success for any given demographic or combination of demographics.

### CCSS.ELA-LITERACY.RL.1.1

Ask and answer questions about key details in a text.

### CCSS.ELA-LITERACY.RL.1.2

Retell stories, including key details, and demonstrate understanding of their central message or lesson.

### CCSS.ELA-LITERACY.RL.1.3

Describe characters, settings, and major events in a story, using key details.

### Craft and Structure:

### CCSS.ELA-LITERACY.RL.1.4

Identify words and phrases in stories or poems that suggest feelings or appeal to the senses.

### CCSS.ELA-LITERACY.RL.1.5

Explain major differences between books that tell stories and books that give information, drawing on a wide reading of a range of text types.

### CCSS.ELA-LITERACY.RL.1.6

Identify who is telling the story at various points in a text.

### Integration of Knowledge and Ideas:

### CCSS.ELA-LITERACY.RL.1.7

Use illustrations and details in a story to describe its characters, setting, or events.

### CCSS.ELA-LITERACY.RL.1.8

(RL.1.8 not applicable to literature)

### CCSS.ELA.LITERACY RL.1.9

Compare and contrast the adventures and experiences of characters in stories.

### Range of Reading and Level of Text Complexity:

### CCSS.ELA-LITERACY.RL.1.10

With prompting and support, read prose and poetry of appropriate complexity for grade 1.

There are hundreds of literacy standards at each grade level within CCSS, rendering use on a manual basis nearly impossible. For every standard, there are countless resources available for teaching the content standard and a similar number of tools for assessing whether the student has mastered these standards, all of which add to the complexity of using CCSS. Many of these resources include activities designed to accommodate individual learning styles. For example, some are designed for visual learners, some are designed for auditory learners, and some are designed for tactile/kinesthetic learners. A similar array of assessment tools also exist. Making optimal use of all this information while customizing learning for individual students is problematic without using an analytics platform.

At a secondary level, the complexity in customizing the education for each student increases exponentially because students have different teachers for different subjects. The following example is from an elementary school classroom where the students stay with the same teacher throughout the day. To customize learning for a single elementary school child a teacher necessarily must:
Determine which curriculum standards the student has not mastered.
Select one or more of them to have the student work on.
Combine the selected curriculum standards under a common theme.
Create an assignment that will lead the student to master the standards.
Identify the student's learning style.
Know what topics interest the individual so the assignment will engage the student.
Locate educational resources that cover the standard using materials matching the student's learning style in a context that interests the student.
Identify other students who share an interest in the context and create a learning team.
Communicate the assignment to the students.
Use observational rubrics to measure student progress.
Record individual student progress without interrupting the students' engagement or learning.
Use observations to determine if the assignment needs to be modified.
Intervene as needed to ensure all students are actively engaged.
Maintain a level of challenge that engages the students without boring them by being too easy or frustrating them by being too difficult.
Find authentic assessment tools to measure the student's progress towards mastery.
Apply the assessments and track progress.
Evaluate assessment results and determine places where the student's understanding needs reinforcement.
Determine why the student is having difficulty with the concept and adapt the assignment by providing supplementary educational resources.
Iterate this process until the student demonstrates mastery.
Examine the strengths and weaknesses of the lesson for the student to enable the next assignment to better meet the student's needs.
Re-evaluate and update the student's preferred learning pedagogy.
Provide comments on the strengths and weaknesses of the learning resources and assessments.
Add any newly identified learning resources to the learning system database.
Tag the resource to enable it to be easily located when it is needed.
Conduct an after-action analysis of the assignment to determine if it could have been designed better, and how.

If the lesson worked well, tag it and store it for future adaptation and use in similar situations.

Analyze the effectiveness and appropriateness of the learning resources and improve the database tagging for the resource.

Provide feedback to the discovery and learning center.

The system of the present invention not only establishes all of these criteria but enhances the probability of success by correlating successful demographics while integrating these demographics into the educational program of a struggling student. Thus, the educator need merely maintain the educational database on a frequent basis with grades and student analysis while the system of the present invention develops the program to meet each of these criteria. It should be apparent that making use of all of the available data from the disparate databases would be unachievable without transforming synergistic data as established by the aggregate database.

The system of the present invention not only generates individualized educational programs but assists educational institutions with allocation of resources. By aggregating, analyzing, learning, and synthesizing the vast volume of data available to schools and school districts, the system identifies where resources are necessary in real time. The dynamic nature of the educational program developed from the aggregate database enables decentralized educational processes placing implementation tools in the hands of the teacher or educator. Decision making is made by the AI of the system based upon statistical learning so that school administration need not be involved in microlevel decision making regarding curriculum, staffing, and even budgets, policies, and facilities. Thus, each individual teacher is provided with the tools necessary to achieve the successful education of any student regardless of the demographics and socio-economic indicators of low probability of success by modeling new programs from combinations of existing programs. The AI turns these demographics and socio-economic indicators into advantages while generating an individualized educational program.

In one embodiment, the system accesses database and finances of individual schools and school districts. Thus, the system is capable of identifying if resources are being adequately directed toward the needs of a student body. Once analysis is complete, the system identifies resources including textbooks and educational content that is uniquely suited for a student body based on its demographics. By identifying these resources across multiple states and school districts, economic analysis may be achieved to determine whether a given school or school district has established equity with other, and sometimes larger school districts that typically have an economic advantage.

Making use of this analysis, an operator of the system of the present invention may now access countless digital-based K-12 education resources that provide excellent results but are otherwise cost prohibitive when only individually targeted to a small number of students having similar demographics. Thus, educational resources maybe bundled in larger volumes and distributed to schools and school districts that may require only small volumes of these resources to meet a small demographic. This provides the ability to achieve volume based discounts that would otherwise not be available. This is all achievable by aggregate data from independent databases that includes multiple schools, school districts, and states conducting comparative analysis identifying previously unknown success parameters.

By accessing financial information of each school or school district, the system identifies funds available to purchase commercial resources that otherwise would not be identified. As commercial resources are consumed, the system tracks status and identifies rate of use and debits financial accounts of a school or school district used to fund these resources. So long as data is maintained in the individual databases, the system provides real time financial reports to the district curriculum director, or any other district designate identifying what funds have been spent or allocated and what funds remain for further use. Correlation may also be made between allocation of funds and success of a student within a demographic of which a customized educational platform has been established. At year end, the system then uses the aggregate data to generate reports tracking spend rates as associated with student demographics enabling a projectable budget for the next school year.

The system enables micro budgets to be prepared that go beyond historical consortiums of small school districts that tend to bundle purchase of supplies such as, for example, paper, textbooks, cleaning supplies, athletic equipment, and the like. Aggregation of individual needs that may be synergistic is generated by the AI and goes beyond conventional consortiums enabling the projection of financial needs to assist the budget preparation.

As set forth briefly above, data security is extremely important. Thus, encryption is used on inbound and outbound data. Prior to importing data from the independent databases, the aggregator encrypts data to be extracted. Further, once the aggregate database has been established for the AI to generate individualized educational programs, the individualized educational programs are encrypted prior to being electronically transmitted to an instructor, educator, or teacher. Still further, when this information is available on the cloud, existence is only a temporary SQL dataset enabling individual access by interested parties after which the information is deleted to protect privacy of a student or educator. These steps are necessary given the private demographic and social economic information that is necessary to achieve successful individualized educational platforms. Encryption is achieved by an encryption element included as part of the system. The encryption element may be provided by a service or generated internally as needed and includes an inbound and an outbound encryption element.

The invention has been described in an illustrative manner; many modifications and variations of the present invention are possible. It is therefore to be understood that within the specification, the description is merely for exemplary and is not to be in any way limiting, and that the invention may be practiced otherwise than is specifically described. Therefore, the invention can be practiced otherwise than is specifically described within the scope of the stated claims following these disclosed embodiments.

What is claimed is:

1. A system for generating a customized instructional platform, comprised of:
a. a processor, for executing a machine learning element and a plurality of separate databases each including independent information relative to disparate factors;
b. said machine learning element, including an aggregator for aggregating data populating said plurality of separate databases thereby generating an aggregate database populated by said disparate factors; and
c. said machine learning element transforming said aggregate database to generate customized instructional platform based upon statistical trends and anomalies learned from said disparate factors populating said aggregate database.

2. The system set forth in claim 1, wherein said machine learning element comprises conventional neural networks (CNN).

3. The system set forth in claim 1, wherein said disparate factors include at least one of educational, demographic and socioeconomic factors.

4. The system set forth in claim 1, wherein said aggregator includes an inbound encryption element for encrypting the data populating said separate databases prior to populating said aggregate database with the data populating said separate databases.

5. The system set forth in claim 1, wherein said aggregator includes an outbound encryption element for encrypting individualized educational platforms prior to transferring said individualized educational platforms to end users.

6. The system set forth in claim 1, wherein said machine learning element generates a predictive outcome from the statistical trends and anomalies identified in said aggregate database thereby defining said customized instructional platform.

7. The system set forth in claim 1, wherein said aggregator standardizes incoherent data accessed from separate databases prior to populating said aggregate database with data contained in the separate databases.

8. The system set forth in claim 1, wherein said disparate factors include at least one of individual demographic, implemented educational platforms, and educational results.

9. The system set forth in claim 1, wherein said aggregator generates a non-structured query language (“SQL”) database.

10. The system set forth in claim 1, wherein said customized instructional platform is defined by success factors determined from individual demographic, implemented educational platforms, and educational results.

11. The system set forth in claim 1, said machine learning element generates statistical probability of results from success factors from individual demographic, implemented educational platforms, and educational results.

12. The system set forth in claim 1, further including an analytics platform for providing alerts when unknown variables are identified within any of the separate databases.
